(19) United States
(12) Patent Application Publication
(10) Pub. No.: US 2023/0120512 A1
(43) Pub. Date: Apr. 20, 2023

(54) CLAIM-BASED AUTHORIZATION ACROSS ORGANIZATIONS

(71) Applicant: Microsoft Technology Licensing, LLC, Redmond, WA (US)

(72) Inventors: Monika BISLA, Issaquah, WA (US); Michael Thomas MCLEAN, Snoqualmie, WA (US)

(73) Assignee: Microsoft Technology Licensing, LLC, Redmond, WA (US)

(21) Appl. No.: 17/490,072

(22) Filed: Sep. 30, 2021

(51) Int. Cl. G06F 21/60

(52) U.S. Cl. CPC G06F 21/604

(57) ABSTRACT

Systems and methods for determining granular authorization of an authorization request for a user operation are provided. In particular, a computing device may receive the authorization request from a user requesting to perform the user operation on a resource, authenticate the user based on identity information included in the authorization request, evaluate the authorization request to identify one or more authorization claims for performing the user operation on the resource, determine one or more claim providers for generating the one or more authorization claims, and fetch the one or more authorization claims from the one or more claim providers. The computing device may further evaluate one or more authorization policies for determining whether the user is authorized to perform the user operation on the resource and determine permissions granted for the authorization request based on the evaluating the one or more authorization policies and the one or more authorization claims.

### BACKGROUND

A collaborative platform provides a collaborative workspace to allow a team within an organization to stay connected and productive by providing easy access to team members, documents, and information. Expanded connectivity enables team members to make informed decisions and improve efficiency. Recent enhancements in collaboration platforms, further improve upon sharing documents, tracking tasks, e-mail efficacy, and idea and information sharing. During collaboration, one of the components of the collaboration platform is to ensure that users can only access system resources to which they have been authorized. However, the collaborative workspace between users of multiple organizations with different roles for accessing or updating multiple resources generates multiple authorization rules, which may be difficult to enforce.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In aspects, a method for determining granular authorization of an authorization request for a user operation is provided. The method includes receiving the authorization request from a user requesting to perform the user operation on a resource and evaluating the authorization request to identify one or more authorization claims for performing the user operation on the resource. The method further includes determining one or more claim providers for generating the one or more authorization claims, where each of the one or more claim providers configured to generate at least one authorization claim of the one or more authorization claims for performing the user operation on the resource, and fetching the one or more authorization claims from the one or more claim providers. Additionally, the method includes evaluating one or more authorization policies to determine whether the user is authorized to perform the user operation on the resource and determining permissions granted for the authorization request based on the evaluating the one or more authorization policies and the one or more authorization claims. In response to determining that the authorization request is granted, the method includes authorizing the user to perform the user operation on the resource.

In further aspects, a computing device for determining granular authorization of an authorization request for a user operation is provided. The computing device including a processor and a memory having a plurality of instructions stored thereon that, when executed by the processor, causes the computing device to perform operations. The operations include receiving the authorization request from a user requesting to perform the user operation on a resource and authenticating the user based on identity information included in the authorization request. The operations further include evaluating the authorization request to identify one or more authorization claims for performing the user operation on the resource and determining one or more claim providers for generating the one or more authorization claims, where each of the one or more claim providers configured to generate at least one authorization claim of the one or more authorization claims for performing the user operation on the resource. Additionally, the operations include fetching the one or more authorization claims from the one or more claim providers and evaluating one or more authorization policies for determining whether the user is authorized to perform the user operation on the resource, where the one or more authorization claims are fetched prior to or during evaluation of the one or more authorization policies. The operations further include determining permissions granted for the authorization request based on the evaluating the one or more authorization policies and the one or more authorization claims and, in response to a determination that the authorization request is granted, authorizing the user to perform the user operation on the resource.

In yet further aspects, a non-transitory computer-readable medium storing instructions for determining granular authorization of an authorization request for a user operation is provided. The instructions when executed by one or more processors of a computing device, cause the computing device to perform operations. The operations include receiving the authorization request from a user requesting to perform the user operation on a resource and authenticating the user based on identity information included in the authorization request. The operations further include evaluating the authorization request to identify one or more authorization claims for performing the user operation on the resource and determining one or more claim providers for generating the one or more authorization claims, where each of the one or more claim providers configured to generate at least one authorization claim of the one or more authorization claims for performing the user operation on the resource. Additionally, the operations include fetching the one or more authorization claims from the one or more claim providers and evaluating one or more authorization policies for determining whether the user is authorized to perform the user operation on the resource. The operations also include determining permissions granted for the authorization request based on the evaluating the one or more authorization policies and the one or more authorization claims and, in response to a determination that the authorization request is granted, authorizing the user to perform the user operation on the resource.

Any of the one or more above aspects in combination with any other of the one or more aspects. Any of the one or more aspects as described herein.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts details directed to a collaborative communication system for facilitating collaborations between users in accordance with examples of the present disclosure;

FIG. 2 depicts details directed to a collaborative communication system for facilitating collaborations between collaboration teams within an organization in accordance with examples of the present disclosure;

FIG. 3 depicts details directed to a collaborative communication system for facilitating collaborations between individuals and/or teams in different organizations in accordance with examples of the present disclosure;

FIG. 4 depicts an exemplary authorization policy in accordance with examples of the present disclosure;

FIG. 5 depicts a block diagram illustrating physical components (e.g., hardware) of a collaborative platform server with which aspects of the disclosure may be practiced;

FIGS. 6A-6B depict a method for determining granular authorization of an authorization request for a user operation in accordance with examples of the present disclosure;

FIG. 7 depicts a block diagram illustrating physical components (e.g., hardware) of a computing device with which aspects of the disclosure may be practiced;

FIG. 8A illustrates a first example of a computing device with which aspects of the disclosure may be practiced;

FIG. 8B illustrates a second example of a computing device with which aspects of the disclosure may be practiced; and

FIG. 9 illustrates at least one aspect of an architecture of a system for processing data in accordance with examples of the present disclosure.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, a collaborative communication system allows individuals or collaboration teams in an organization (also referred to as a tenant) to create a collaborative enterprise environment on a collaborative platform (e.g., Microsoft® Teams®) with other individuals or collaboration teams within the organization and/or with other individuals or collaboration teams that belong to a different organization. Each user of the collaborative platform may customize the user’s collaborative environment. Each collaboration team includes a group of team members and may have more than one collaborative channel shared among the team members. For example, a member of a collaboration team in an organization may create a collaborative channel to work on a project with other individuals in the same collaboration team and/or one or more members from a different collaboration team in the same organization. Collaboration may involve phone calls (e.g., IP-based calls), chat threads, email threads, channel conversations, document sharing, task tracking, and the like. Additionally, or alternatively, the collaborative channel may be shared with one or more individuals or teams outside of the organization (e.g., an external organization).

Each individual who has been invited or added to the collaborative channel may be assigned a specific set of rights (e.g., to access and interact with content in the collaborative channel) based at least in part on a type of the collaborative channel and an identity of the individual (e.g., within or outside the collaboration team, internal or external of the organization). For example, the type of a collaborative channel (e.g., standard, private, and shared) may be defined by an individual when creating the collaborative channel (also referred to as an owner of the collaborative channel). It should be appreciated that, in some aspects, the owner and/or one or more authorized members of the collaborative channel may modify the type of collaborative channel after the collaborative channel has been created. Additionally, it should also be appreciated that there may be multiple owners associated with the collaborative channel and owners may have additional authority to make changes to the collaborative channel than other members. As described above, regardless of the type of collaborative channel, an individual who is not a member of the collaboration team may be invited and/or added to the collaborative channel as a channel-only member. Additionally, in some aspects, a member of the collaboration team may also be explicitly added to a particular collaborative channel as a channel-only member. In such aspects, if the member is removed from the collaboration team, the member will retain access to the particular collaborative channel to which the member was added as the channel-only member.

As described above, the type of a collaborative channel may include standard, private, and shared. The standard collaborative channel is configured to establish an open collaboration within the collaboration team and inherits a roster (e.g., a full membership list) corresponding to the collaboration team. In other words, the standard collaborative channel and its contents are visible to every team member in the collaboration team. Even so, the owner of the collaborative channel may still maintain more rights than the other team members, such as rights to make changes to the roster, schedule meetings, grant rights to other members, and the like. It should be appreciated that, in some aspects, the standard collaborative channel may be public. For example, users in the same organization may access content in standard public channels.

The private collaborative channel is a channel where membership may be a subset of the team members in a collaboration team and/or a subset of members of an organization more broadly. The private collaborative channel and its contents are hidden from other team members (or organization members) who are not members of the private collaborative channel. For example, anyone in the collaboration team may create a private collaborative channel and invite one or more particular team members in the collaboration team to access the private collaborative channel. In fact, a team owner (e.g., a person who created the collaboration team) may not be a member of the private collaborative channel.

The shared collaborative channel allows cross-team collaboration between multiple collaborative teams within the same organization or across multiple organizations. The shared collaborative channel allows members in different teams to collaborate as if they were all members of the same collaboration team. When a shared collaborative channel is created, the originating member may be referred to as an originating owner. The originating owner is a member of an originating organization (e.g., internal organization) and may be (but is not required to be) a member of an internal collaboration team, for instance. The originating owner may invite members to the shared collaborative channel from different collaboration teams (e.g., internal collaboration teams) within the same organization (e.g., internal organization) and/or may invite members from different organizations (e.g., external organizations). If a member is associated with the same organization as the originating owner, the member is an internal member; whereas if a member is not associated with the same organization as the originating owner, the member is an external member. An internal member may be granted rights of an owner by the originating owner, which may include some or all of the rights held by the originating owner. In aspects, an external member may be granted rights as an external owner, but may not be granted all of the rights of an internal designated owner or the originating owner. That is, an external designated owner may not have rights to add or remove internal members from the membership roster of the shared collaborative channel but may have rights to add or remove external members (e.g., users from the same organization as the external designated owner). For example, if Organization A is collaborating with an external consulting firm like Organization B on a project, Organization A may not know how many individuals Organization B has allocated or when consultants will roll on or off the project. In such an example, Organization A may delegate managing a list of users within Organization B to an external owner member of Organization B. This allows Organization A to easily collaborate with Organization B without having to identify and update each and every consultant that rotates throughout the project.

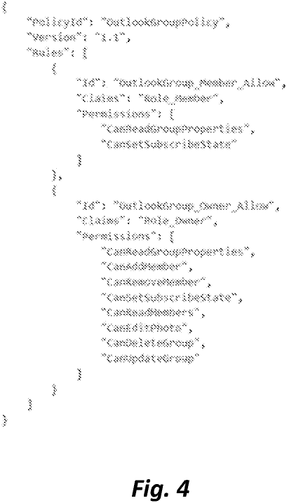

Additionally, each member of a shared collaborative channel may choose to add or link the shared collaborative channel directly to one or more of the member’s collaboration teams (e.g., a member’s primary collaboration team), as shown in FIGS. 4A and 4B. This prevents the member from needing to move out of context from one collaboration team to view content in the shared collaborative channel, which may be associated with a different collaboration team of the same organization or with a different organization entirely. It should be appreciated that edits (e.g., additions, deletions, changes) made to the content in the collaborative channel may be reflected in near real-time across user systems. For example, while an edit is being made to the content on one user system, the edit may be reflected at substantially (or nearly) the same time on another user system. “Near” real-time (or substantially real-time) may account for a minimal delay associated with transmission and synchronization of changes due to resource availability, processing speeds, network bandwidth, and the like.

In the illustrative aspect, when a new private or shared collaborative channel is created, a new substrate group may be provisioned within a resource tenant (i.e., where the new private or shared collaborative channel lives). The new substrate group is associated with the new collaborative channel and serves as an authority for membership (e.g., an identity management directory) inside the new collaborative channel. For example, the substrate group may contain a roster that includes a list of users and computers that are authorized to access resources or content associated with the collaborative channel. As such, a direct mapping (e.g., a 1:1 mapping) is established between the collaborative channel and the substrate group. The substrate group includes a group database for storing content (e.g., membership, messages, calendar entries) that are shared between members of the associated collaborative channel. Such content may be received, uploaded, or otherwise generated by the members and may be made available to multiple applications accessible by the members, including the collaborative platform, a calendar/messaging application, a planner application, a notebook application, and the like. It should be appreciated that the substrate group is independent from other identity management directories (e.g., Azure Active Directory) that may be associated with the collaboration team.

By creating a collaborative channel with its own substrate group, an individual may be added to a specific collaborative channel (e.g., channel-only members) for collaboration without being a member of the collaboration team. This allows the collaborative communication system to limit the access of channel-only members to content of the specific collaborative channel only. It should be appreciated that this is a significant improvement over current collaborative systems where all channels within a collaboration team share the same roster (e.g., same identity management directory) and the same group database, which in the case of a shared channel would result in all members, including users outside of the resource tenant (i.e., from different tenants), to have at least read access all content of the collaborative team. By bifurcating the membership roster of a shared collaborative channel from the general organizational directories, additional flexibility in assigning content permissions (e.g., read/write) and/or channel rights (e.g., changing membership, adding tasks, scheduling meetings, etc.) to both internal and external members can be achieved.

Additionally, authorization policies may include authorization rules that define content permissions and/or channel rights for accessing content on a collaborative channel. Generally, the authorization rules are defined in source code. As scenarios become more complex (e.g., users in different roles from multiple tenants accessing or updating multiple resources), authorization logic may get sprinkled across multiple layers of code. It may become difficult to determine what permissions should be granted to a user in a particular role at a particular time without a thorough inspection of the source code. In addition, changes to such authorization logic may be difficult to review, validate, and may be prone to security issues.

Accordingly, in the illustrative aspect, claim-based authorization is used to grant granular permissions to users for performing certain operations on one or more resources on a collaborative channel. To do so, authorization rules are declared in a single centralized policy database (e.g., database 518). However, it should be appreciated that, in some embodiments, authorization rules may be retrieved or obtained by making appropriate application programming interface (API) calls to one or more policy providers (e.g., substrate policy provider), which may be temporarily stored in a shared cache. Claims for entities (e.g., identity, resource, relation, target, etc.) are dynamically generated on demand based on a context of an authorization request during a request execution. In aspects, a “claim” (or “authorization claim”) refers to a verifiable statement about an entity (e.g., a name of a user). For instance, a claim may be in the form of a “type-name-value triplet” that represents the type of entity, the name of the claim, and a claim value. A claim provider may generate the claim in a form (often referred to as a “token”) that can be used by an application to verify an identity of the entity. As users may have different roles at different times or different permissions with respect to different resources, an authorization policy may be consulted to determine whether the verified entity has authority (or permission) to perform a requested operation. As such, claim-based authorization enables granular permissions to be granted to users at runtime for performing certain operations on one or more resources.

It should be appreciated that although, for exemplary purposes, described embodiments generally relate to applications, e.g., such as email applications, chat applications, collaborative platforms, and the like, the present methods and systems are not so limited. For example, collaboration content described herein may be used to provide collaborative experiences in applications other than messaging applications, such as word processing applications, spreadsheet applications, notebook applications, presentation applications, instant messaging or chat applications, social networking platforms, and the like.

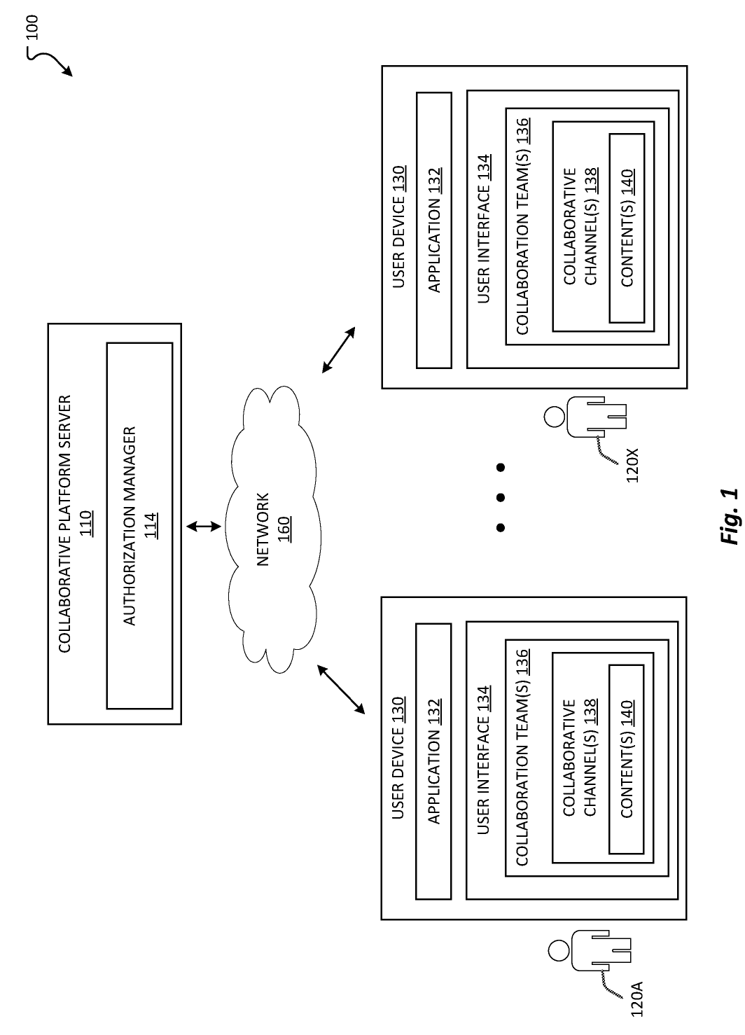

Referring now to FIG. 1, an exemplary collaborative communication system 100 for facilitating collaborations between users is provided, in accordance with an embodiment of the present disclosure. To do so, the collaborative communication system 100 includes a collaborative platform server 110 that is communicatively coupled to a plurality of computing devices 130 associated with users (e.g., members) 120 in via a network 160. The network 160 may include any kind of computing network including, without limitation, a wired or wireless local area network (LAN), a wired or wireless wide area network (WAN), and/or the Internet.

Specifically, FIG. 1 illustrates an overview of an example collaborative communication system 100 through which a member of a collaboration team 136 in an organization may collaborate with another member within or outside of the collaboration team 136 in the same or different organization via a collaborative platform server 110. The collaborative platform server 110 is associated with a collaborative platform, such as Microsoft Teams®. In the illustrative aspect, the collaborative platform server 110 includes an authorization manager 114. The authorization manager 114 may manage and authorize authorization requests from users to perform user operations on one or more resources (e.g., in a shared collaborative channel). Specifically, the authorization manager 114 may generate granular authorization of a request to perform a user operation on a resource by evaluating appropriate authorization policies at runtime. To do so, the authorization manager 114 is configured to evaluate an authorization request from a user to perform a user operation on a resource associated with a shared collaborative channel. For example, the user operation may include adding or removing a member or viewing or uploading content to the resource.

Upon receiving the authorization request, the authorization manager 114 is configured to authenticate the user based on identity information (e.g., an identity token or an identity claim) included in the authorization request. In other words, the authorization manager 114 is configured to verify that the user is in compliance with cross-tenant access policies defined by a home tenant of the user and a resource tenant (i.e., where the resource is hosted). For example, the cross-tenant access policy on the home tenant may indicate whether the home tenant allows its members to access resources on another tenant. Whereas, the cross-tenant access policy on the resource tenant may indicate whether the resource tenant allows external members to access resources on the resource tenant.

The authorization manager 114 is further configured to prefetch one or more claims based on anticipated permissions associated with the authorization request for authenticating the user. To prefetch the one or more claims, the authorization manager 114 may be configured to determine a potential set of claims for determining permissions of the authorization request and determine claim providers that can provide values for those potential claims. To do so, the authorization manager 114 may map the authorization request to authorization permissions, which may be static. Once the authorization permissions are determined, the authorization manager 114 may further determine a list of potential claims that may be necessary to evaluate those permissions. The authorization manager 114 may be configured to cause the claims to be generated by the claim providers and prefetch the claims associated with the authorization request.

Moreover, the authorization manager 114 is configured to determine available claim providers associated with the user operation included in the authorization request. For example, if the user operation that is being requested to be authorized is adding a member to the shared collaborative channel, the authorization manager 114 may call a specific API for updating group members and check for permission for adding member for the authenticated user. The specific API may include several available claim providers or entities associated with adding a member to the shared collaborative channel.

Additionally, the authorization manager 114 is configured to select one or more authorization policies that need to be evaluated based on one or more claims (e.g., claims based on the authorization request, prefetched claims, and/or claims that may be generated by one or more available claim providers). The authorization manager 114 is further configured to fetch and evaluate the selected authorization policies from a centralized policy database that stores a plurality of authorization policies. To do so, the authorization manager 114 is configured to fetch the claims on demand as the selected authorization policies are being evaluated to determine if the claims match values defined in the selected authorization policies.

Content 140 may be shared and/or updated by one or more members of the shared collaborative channel 138 via an application 132 that is communicatively coupled to the collaborative platform server 110. For example, the content may include documents, agenda items, calendar items, action or task items, notes, or the like. It should be appreciated that any content (e.g., materials, documents, data, etc.) discussed or shared during a collaboration session may be automatically associated with the respective collaborative channel 138 and commonly stored (e.g., a substrate group database associated with the shared collaborative channel) that is accessible only by the members of the shared collaborative channel 138, based on any applicable permissions or rights to the content assigned to each member. In other words, the collaborative communication system 100 may provide a concurrent multi-user interaction and a real-time collaboration between the members of the shared collaborative channel 138 - whether inside or outside of an organization.

As described above, each user 120 of the collaborative platform may customize the user’s collaborative environment, which is displayable on a user interface 133 of the user device 130. It should be appreciated that each member of the shared collaborative channel 138 may choose where to link or mount the shared collaborative channel 138 within the user’s collaborative environment. However, it should be appreciated that, in some aspects, the shared collaborative channel 138 may not be linked to a collaboration team 136 but instead linked to the user’s collaborative environment as a standalone channel.

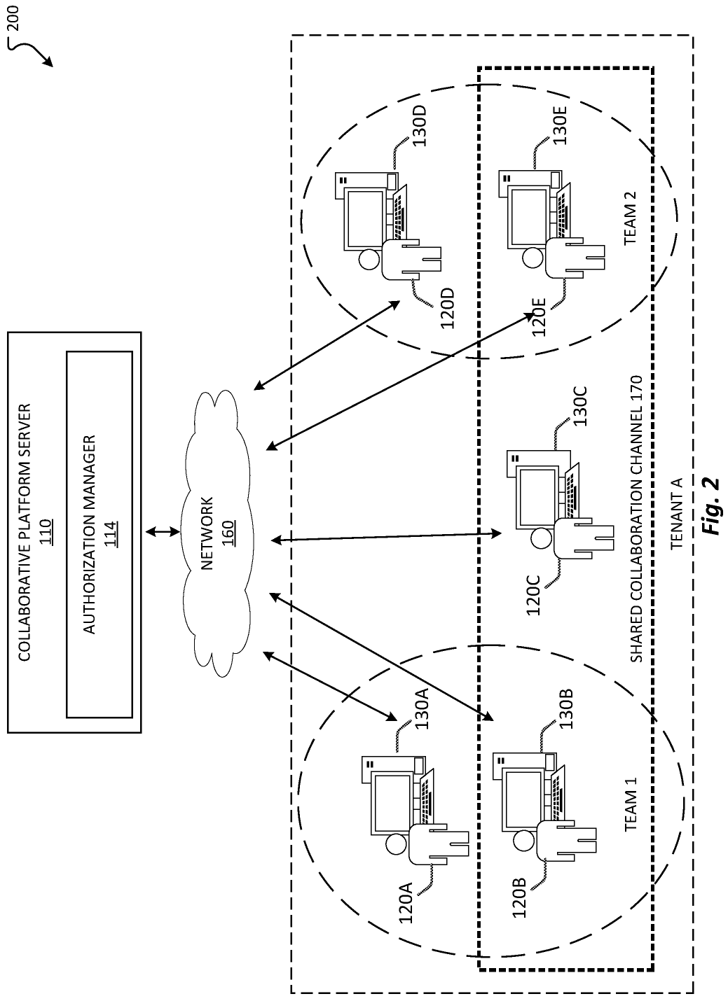

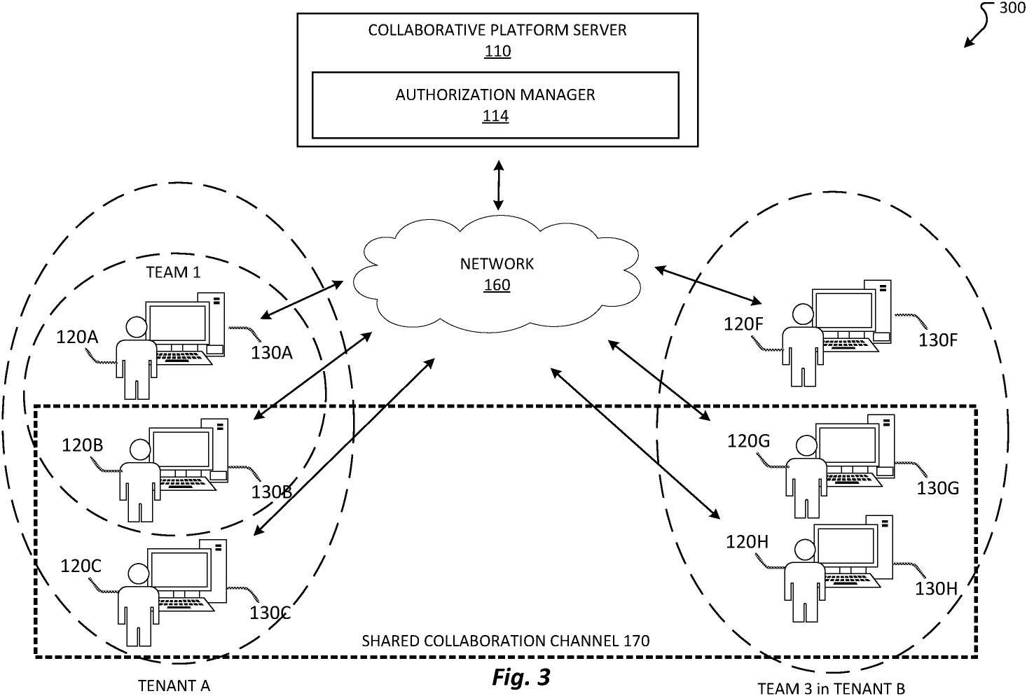

Referring now to FIGS. 2 and 3, an exemplary shared collaborative channel is illustrated. Specifically, FIG. 2 depicts an exemplary collaborative communication system 200 for facilitating collaborations between different collaboration teams within the same organization, in accordance with an embodiment of the present disclosure. In the illustrative aspect, the collaborative communication system 200 allows a member of one collaboration team in an organization to create a shared collaborative channel 170 on a collaborative platform with other individuals and/or collaboration teams within the same organization. To do so, the collaborative communication system 200 includes a collaborative platform server 110 that is communicatively coupled to a plurality of computing devices 130A-130E associated with users (e.g., members) 120A-120E in the same organization, Tenant A, via the network 160. As described above, the network 160 may include any kind of computing network including, without limitation, a wired or wireless local area network (LAN), a wired or wireless wide area network (WAN), and/or the Internet.

As shown in FIG. 2, Collaboration Team 1 has two team members 120A, 120B. Each team member 120A, 120B has a computing device 130A, 130B that is communicatively coupled to the collaborative platform server 110 to achieve collaboration within Collaboration Team 1. Additionally, Collaboration Team 1 may have more than one collaborative channel shared among the team members 120A, 120B. For example, the team member 120A (also referred to as a host or an originating channel owner from an originating collaboration team) may create a shared collaborative channel to initiate cross-team collaboration with Collaboration Team 2 in the same organization, Tenant A. When the shared collaborative channel is created, the membership of the shared collaborative channel may be defined as an aggregation of members from Collaboration Team 1 (i.e., the originating collaboration team) and Collaboration Team 2 (i.e., a recipient collaboration team). Additionally, the originating channel owner 120A may also invite a member 120C of Tenant A, who is not a member of any collaborative channel, to the shared collaborative channel.

Alternatively, or additionally, as depicted in FIG. 3, an exemplary collaborative communication system 300 may facilitating collaboration between collaboration teams across different organizations (i.e., cross-tenants), in accordance with an embodiment of the present disclosure. Specifically, in the illustrative aspect, the collaborative communication system 300 allows a member of one organization (whether a member of a collaboration team within the organization or not) to create a shared collaborative channel with other individuals and/or collaboration teams from another organization. To do so, the collaborative communication system 300 includes a collaborative platform server 110 that is communicatively coupled to a plurality of computing devices 130A-130C associated with members 120A-120C in Tenant A and a plurality of computing devices 130F-130H associated with members 120F-120H in Tenant B via the network 160.

As shown in FIG. 3, Collaboration Team 1 has three team members 120A, 120B. Each team member has a computing device 130A, 130B that is communicatively coupled to the collaborative platform server 110 to achieve collaboration within Collaboration Team 1. Additionally, Collaboration Team 1 may have more than one collaborative channel shared among the team members 120A, 120B. For example, the team member 120A (also referred to as a host or an originating channel owner from an originating collaboration team) may create a shared collaborative channel to initiate cross-team collaboration with Collaboration Team 3 from a different organization, Tenant B. When the shared collaborative channel is created, the membership of the shared collaborative channel may be defined as an aggregation of members from Collaboration Team 1 (i.e., the originating collaboration team) and Collaboration Team 3 (i.e., a recipient collaboration team). Additionally, the originating channel owner 120A may also invite a member 120C of Tenant A, who is not a member of any collaborative channel, to the shared collaborative channel.

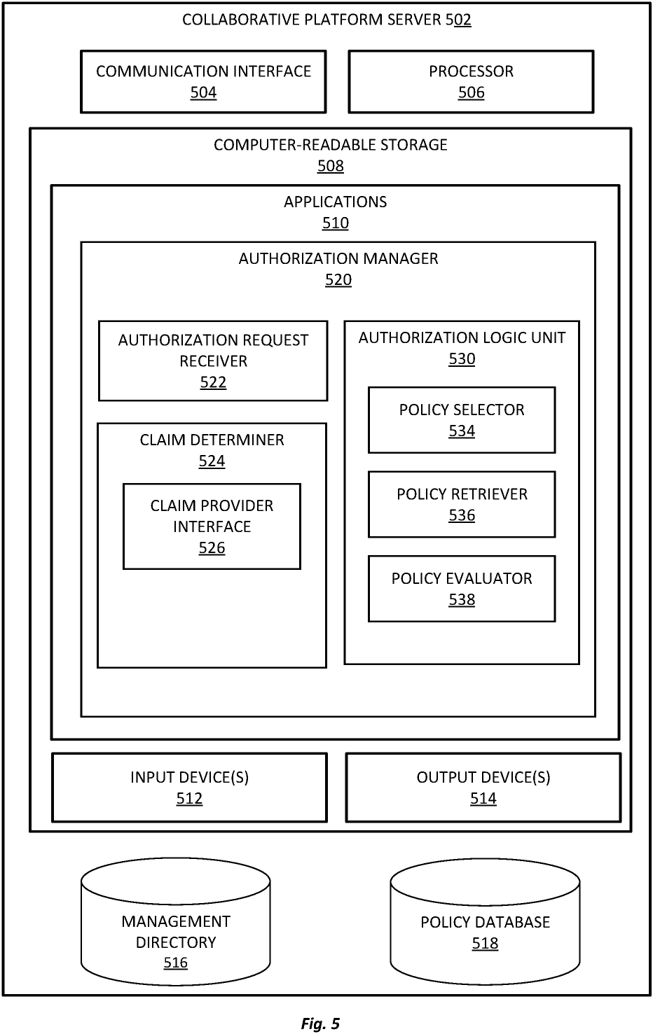

Referring now to FIG. 5, the collaborative platform server 502 in accordance with examples of the present disclosure is provided. The collaborative platform server 502 may be the same as or similar to the collaborative platform server 110 previously described in FIGS. 1-4. The collaborative platform server 502 may include a communication interface 504, a processor 506, a computer-readable storage 508, one or more input devices 512, and one or more output devices 514. In examples, the communication interface 504 may be coupled to a network and receive an authorization request. Additionally, one or more applications 510 may be provided by the collaborative platform server 502. The one or more applications 510 may include an authorization manager 520, which may be the same as or similar to the authorization manager 114 previously described in FIGS. 1-3. The authorization manager 520 is configured to manage authorization of a service to ensure that a user may only access system resources to which the user has been authorized. To do so, the authorization manager 520 further includes an authorization request receiver 522, a claim determiner 524, and an authorization logic unit 530. The authorization request receiver 522 is configured to receive an authorization request to perform a user operation on a resource (e.g., a shared collaborative channel). For example, the user operation may include adding or removing a member or viewing or uploading content to the resource.

The claim determiner 524 may include a claim provider interface 526 for calling one or more application programming interfaces (APIs) associated with one or more claim providers. For example, in response to the claim determiner 524 predicting claims that may be necessary based on the authorization request, the claim provider interface 526 may be configured to call APIs associated with corresponding claim providers to prefetch the predicted claims. In another aspect, the claim provider interface 526 may be embodied as an internal object or entity that generates claims for authorization. In this case, the claim determiner 524 may call the claim provider interface to prefetch the predicted claims. A claim may be in a type-name-value triplet format that represents the type of entity, the name of the claim, and its value. For example, the type of entity may include identity, resource, relation, and target. The claim provider interface 526 may be configured to determine available claim providers associated with a user operation included in the authorization request.

For example, if a requested user operation to be authorized is adding a member to a shared collaborative channel, the claim provider interface 526 may call a specific API for updating group members (e.g., UpdateGroupMembers API) and check for permission for adding member (e.g., ‘CanAddMember’ permission) for the authenticated user. The specific API may include several available claim providers or entities associated with adding a member to the shared collaborative channel. For example, as shown in Table 1 below, the API for updating group members may include at least three claim providers: a Group Entity for generating a Resource claim, an Actor Entity for generating an Identity claim, and an ActorGroupRelation Entity for generating a Relation claim.

TABLE 1

| Entity | Claim Type | <Claim Name, ClaimValue> Pairs |
|---|---|---|
| Group | Resource | “Type, OutlookGroup” |
| Actor | Identity | “IsConsumer, False”, “IsGuest, False” |
| ActorGroupRelation | Relation | “Role:Owner”, “IsLastOwner:True” |

The claim determiner 524 is configured to determine a potential set of claims that might be needed for determining permissions of the authorization request. For example, if the requested user operation to be authorized is adding a member to a shared collaborative channel, the claim determiner 524 may determine a potential set of claims that might be needed based on calling one or more APIs for adding a member to a shared collaborative channel. Additionally, the claim determiner 524 and/or the claim provider interface 526 may further determine claim providers that can generate the potential claims. For example, a Group Entity may generate a Resource claim, an Actor Entity may generate an Identity claim, and an ActorGroupRelation Entity may generate a Relation claim.

The authorization logic unit 530 is configured to evaluate the predicted claims based on authorization policies. It should be appreciated that the authorization policies are selected and fetched based on a requested user operation. To do so, the authorization logic unit 530 further includes a policy selector 534, a policy retriever 536, and a policy evaluator 538.

The policy selector 534 is configured to evaluate an authorization request based on a combination of an actor (e.g., an identify of a requesting user), a resource (e.g., messages, membership roster, document store, and/or calendar), and an action/operation (e.g., modifying membership on a shared collaborative channel and/or editing a document) and select one or more authorization policies that need to be evaluated for the authorization request. For example, if the authorization request is being made against an Outlook Group Resource, the policy selector 534 may determine that all the authorization policies for outlook groups should be evaluated. In other example, if the authorization request is being attempted to add another user to a shared collaborative channel by a user, the policy selector 534 may select all the policies for shared collaborative channels.

The policy retriever 536 is configured to fetch the one or more policies from a centralized policy database 518 that stores a plurality of authorization policies. It should be appreciated that, in some aspects, the policy retriever 536 may fetch the one or more policies by making an appropriate API call and produce the one or more policies in a format understood by the authorization logic unit 530. The policy retriever 536 may temporarily store the one or more policies in a shared cache to avoid making duplicate network calls for the same data within same request or inter-request within a short time span.

As described above, the authorization policies may define which permissions are available to particular classifications of users (e.g., owners, internal members, external members, and/or viewers/visitors) based on the particular resource requested. These policies can be used to generate granular permissions for certain operations based on the particular classification of the user and the resource. For example, for a shared collaborative channel, the classification of the user may indicate whether the user is an internal owner of the shared collaborative channel from a resource tenant (e.g., where the shared collaborative channel is hosted), an external owner from a home tenant (e.g., where the user resides), or an internal or external member of the shared collaborative channel.

The policy evaluator 538 is configured to evaluate selected policies against claims to determine permissions granted for a user operation. To do so, the policy evaluator 538 fetches one or more claims from respective claim providers on demand as the policy evaluator 538 is evaluating the selected authorization policies. Referring back to the example above, if the authorization request is being attempted to add another user to a shared collaborative channel by a user, the policy evaluator 538 compares one or more claims that would be expected for the user against one or more policies that are selected based on the operation that the user is attempting to perform. If the one or more claims match the one or more selected policies, the user is allowed to add another user to the shared collaborative channel. However, if there is a mismatch between the one or more claims and the one or more selected policies, no claim is generated, and the user cannot add another user.

As shown in FIG. 4, a selected authorization policy may include a rule that defines whether a particular user operation by the user is authorized. Specifically, FIG. 4 illustrates an exemplary policy, called OutlookGroupPolicy, with two rules that define permissions granted based on a role of a user. A first rule includes a list of permissions that are granted to a member of a messaging group (e.g., Outlook Group), and a second rule includes a list of permissions that are granted to an owner of the messaging group (e.g., Outlook Group). Specifically, a member of the Outlook Group can read group properties and set a subscribe state. However, a member cannot, for example, add or remove a member. On the other hand, in addition to read group properties and set subscribe state, an owner of the Outlook Group can further, among other things, add or remove a member, and delete or update the group.

For example, Alice is a group owner of a messaging group called Friends, and she wants to add Bob as a member of Friends. To do so, Alice sends an authorization request for adding Bob as a member. In response, the collaborative platform server calls a particular API for updating the Friends group as a target group (e.g., UpdateGroupMembers API) associated with the messaging server (e.g., Outlook Service). The authorization manager 520 authenticates Alice (e.g., based on an identity token) and performs a number of steps to determine whether Alice should be granted permission to add a member to the Friends group (e.g., a CanAddMember permission). For instance, the authorization manager 520 may determine available claim providers associated with the particular API and may prefetch one or more claims anticipated to be necessary for Alice’s request to add a member. Authorization manager 520 may then select one or more authorization policies, e.g., based on the requested operation (e.g., add member), Alice’s role in the group (e.g., owner, member, visitor, etc.), and/or the prefetched claims for the resource that is the target of the request (e.g., Friends Outlook Group). For example, when the Resource claim(s) are accessed, a type of the target group may be returned, e.g., OutlookGroup. Then a policy associated with the OutlookGroup may be selected (shown in FIG. 4) and rules defined by the OutlookGroupPolicy may be evaluated in order of definition. It should be appreciated that rules directed to the requested permission, based on the authorization request (e.g., add member), may be evaluated for optimization. In this case, rules directed to the CanAddMember permission may be evaluated first or may be exclusively evaluated. In the above example, since Alice is an Owner of the group, an ActorGroupRelation claim provider will set a Role claim to owner. Accordingly, when the authorization manager 520 evaluates the rules in the OutlookGroupPolicy, the second rule will match. Since matched rule has ‘CanAddMember’ permission, the authorization manager 520 returns true and, therefore, the authorization request is promoted to a task layer to update the membership of the OutlookGroup. Similarly, if Bob (who is not a group owner) were to make a UpdateGroupMembers request, the request would fail as unauthorized because the Role_Owner claim would not be generated for Bob.

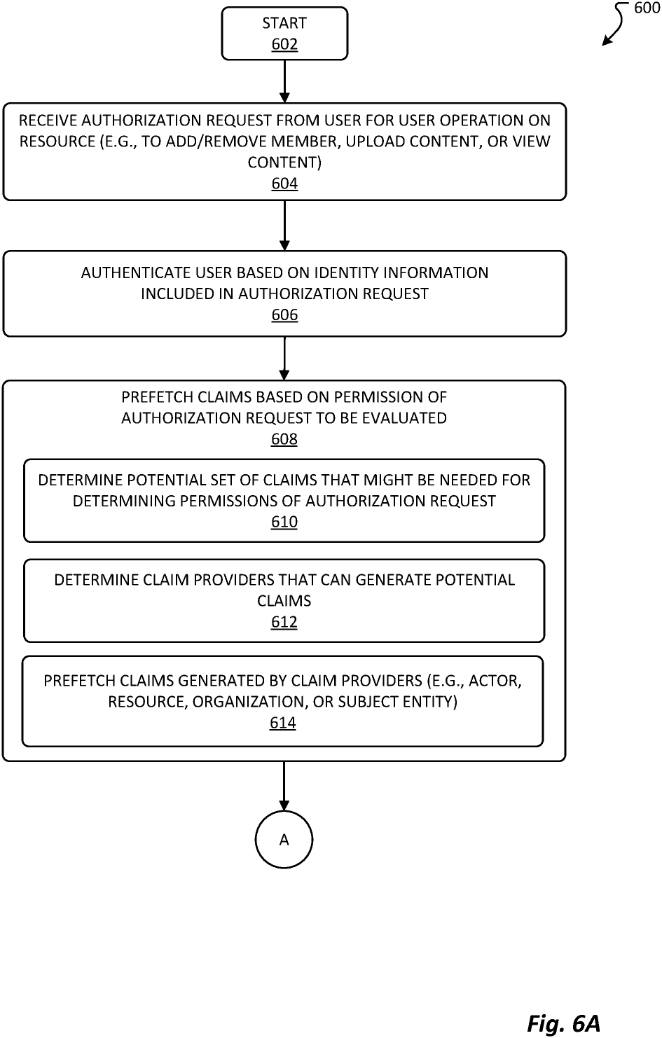

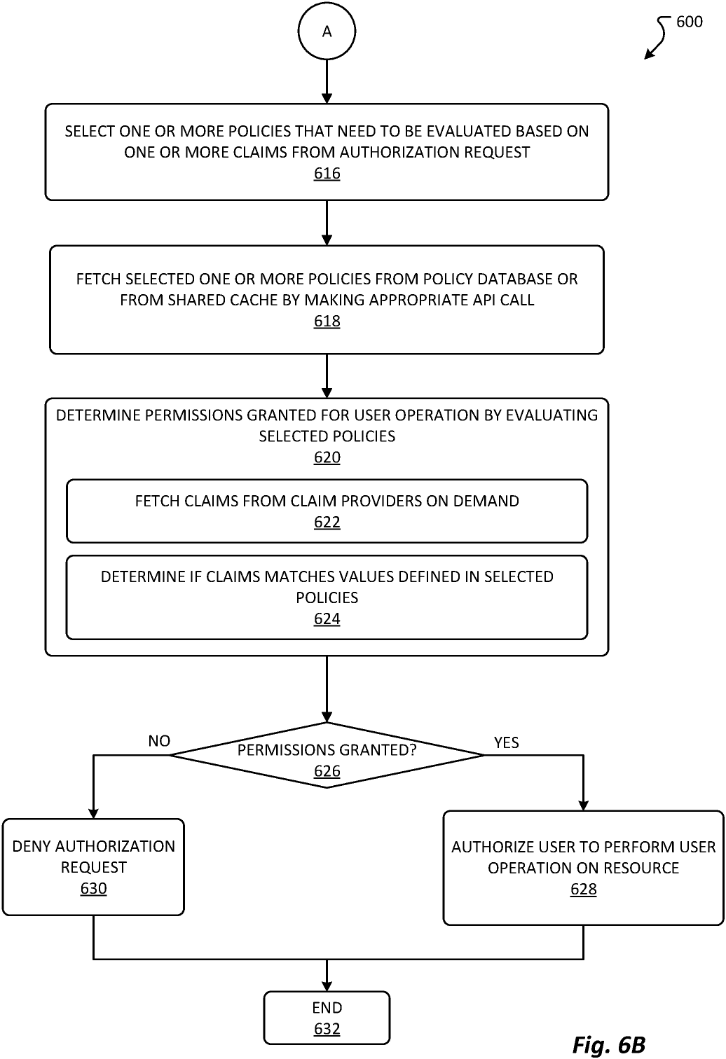

Referring now to FIGS. 6A-6B, a method 600 for determining granular authorization of a request to perform a user operation on a resource by evaluating appropriate authorization policies at runtime in accordance with examples of the present disclosure is provided. A general order for the steps of the method 600 is shown in FIGS. 6A-6B. Generally, the method 600 starts at 602 and ends at 632. The method 600 may include more or fewer steps or may arrange the order of the steps differently than those shown in FIGS. 6A-6B. In the illustrative aspect, the method 600 is performed by a collaborative platform server (e.g., a collaborative platform server 110, 502, 800). For example, the collaborative platform server may be, but is not limited to, a web-server, a server instance on a cloud platform, a cloud-enabled operating system, or any other suitable computing device that is capable of communicating with one or more computing devices (e.g., a computing device 130) associated with one or more members (e.g., 120) of one or more organizations. For example, the collaborative platform server may be any suitable computing device that is capable of communicating with the computing device. As described above, in some aspects, the collaborative platform server may be a group of servers that are communicatively coupled to one another. The method 600 can be executed as a set of computer-executable instructions executed by a computer system and encoded or stored on a computer readable medium. Further, the method 600 can be performed by gates or circuits associated with a processor, Application Specific Integrated Circuit (ASIC), a field programmable gate array (FPGA), a system on chip (SOC), or other hardware device. Hereinafter, the method 600 shall be explained with reference to the systems, components, modules, software, data structures, user interfaces, etc. described in conjunction with FIG. 1.

The method 600 starts at 602, where flow may proceed to 604. At 604, the collaborative platform server receives an authorization request from a user to perform a user operation on a resource (e.g., associated with a shared collaborative channel). For example, the user operation may include adding or removing a member or viewing or uploading content to the resource.

Upon receiving the authorization request, in operation 606, the collaborative platform server authenticates the user based on identity information included in the authorization request. The identity information may be an identity token or an identity claim. Additionally, the collaborative platform server may verify that the user is in compliance with cross-tenant access policies defined by a home tenant of the user and a resource tenant (i.e., where the resource is hosted). For example, the cross-tenant access policy on the home tenant may indicate whether the home tenant allows its members to access resources on another tenant. Whereas, the cross-tenant access policy on the resource tenant may indicate whether the resource tenant allows other external members from another tenant to access resources on the resource tenant.

In some embodiments, while the user is being authenticated, the collaborative platform server may prefetch one or more claims based on permissions associated with the authorization request, as indicated in operation 608. To do so, in operation 610, the collaborative platform server may determine a potential set of claims that might be needed for determining permissions of the authorization request. Specifically, the collaborative platform server may map the authorization request to authorization permissions, which may be static. Once the authorization permissions are determined, the collaborative platform server may further determine a list of potential claims that may be necessary to evaluate those permissions.

For example, if the requested user operation is adding a member to a shared collaborative channel, the collaborative platform server may determine a potential set of claims needed based on calling an API for adding a member to a shared collaborative channel. Subsequently, the collaborative platform server may determine claim providers that can provide values for those potential claims. For example, a Group Entity may generate a Resource claim, an Actor Entity may generate an Identity claim, and an ActorGroupRelation Entity may generate a Relation claim. The collaborative platform server may cause the claims to be generated by the claim providers and prefetch the claims associated with the authorization request.

Once the user is authenticated in operation 606, the collaborative platform server determines available claim providers associated with the user operation included in the authorization request, as indicated in operation 612. Referring back to the example above, if the user operation that is being requested to be authorized is adding a member to the shared collaborative channel, the collaborative platform server may call a specific API for updating group members (e.g., UpdateGroupMembers API) and check for permission for adding member (e.g., ‘CanAddMember’ permission) for the authenticated user. The specific API may include several available claim providers or entities associated adding a member to the shared collaborative channel. For example, as shown in Table 1 above, the API for updating group members may include at least three claim providers: a Group Entity for generating a Resource claim, an Actor Entity for generating an Identity claim, and an ActorGroupRelation Entity for generating a Relation claim. Once the available claim providers are determined, the collaborative platform server may prefetch one or more claims generated by the available claim providers, as indicated in operation 614. Subsequently, the method 600 proceeds to operation 616 in FIG. 6B as shown by the alphanumeric character A in FIGS. 6A and 6B.

In operation 616, the collaborative platform server selects one or more authorization policies that need to be evaluated based on one or more claims from the authorization request. As described above, the collaborative platform server may evaluate the authorization request based on a combination of an actor (e.g., an identify of a requesting user), a resource (e.g., messages, membership roster, document store, and/or calendar), and an action/operation (e.g., modifying membership on a shared collaborative channel and/or editing a document) and select one or more authorization policies that need to be evaluated for the authorization request. For example, if the authorization request is for adding a user to a shared collaborative channel, the collaborative platform server selects all authorization policies associated with the shared collaborative channel.

Once the one or more authorization policies are selected, the collaborative platform server may fetch the selected authorization policies in operation 618. In the illustrative aspect, the collaborative platform server fetches the selected authorization policies from a centralized policy database that stores a plurality of authorization policies. As described above, such authorization policies may define which permissions are available to particular classifications of users for a particular resource. This enables generation of granular permissions for certain operations based on particular classification of the user against a particular resource. For example, for a shared collaborative channel, the classification of the user may indicate whether the user is an internal owner of the shared collaborative channel from a resource tenant (e.g., where the shared collaborative channel is hosted), an external owner from a home tenant (e.g., where the user resides), or an internal or external member of the shared collaborative channel.

Alternatively, the collaborative platform server may fetch the selected authorization policies by making an appropriate API call to one or more policy providers (e.g., a substrate policy provider associate with a substrate group of a shared collaborative channel). It should be appreciated that some authorization policies may be stored in a shared cache to avoid making duplicate network calls for the same data within the same authorization request or inter-request within a short time span.

Subsequently, in operation 620, the collaborative platform server determines whether permissions are available for a requested user operation by evaluating the selected one or more authorization policies. To do so, the collaborative platform server fetches one or more claims from respective claim providers at runtime as the collaborative platform server is evaluating the selected authorization policies or, as discussed above, the collaborative platform server prefetches and caches predicted claims from the respective claim providers. For example, a selected authorization policy may include a rule that defines whether a particular user operation (e.g., adding a member to a shared collaborative channel) by the user is authorized. The rule may indicate that only an owner of a shared collaborative channel may add a member to the shared collaborative channel. In such an example, the collaborative platform server may fetch (or prefetch) an Identity claim that indicates whether the user is an owner or a member of the shared collaborative channel. Once the Identity claim has been fetched, the collaborative platform server determines whether the user is an owner of the shared collaborative channel, in which case, the shared collaborative channel determines that the claim matches the value defined in the selected authorization policy.

If the shared collaborative channel determines that the permission is granted for the user operation in operation 626, the method 600 advances to operation 628 to authorize the user to perform the user operation. Subsequently, the method 600 may end at 632.

If, however, the shared collaborative channel determines that the permission is not granted for the user operation, the method 600 advances to operation 630 to deny the authorization request. Subsequently, the method 600 may end at 632.

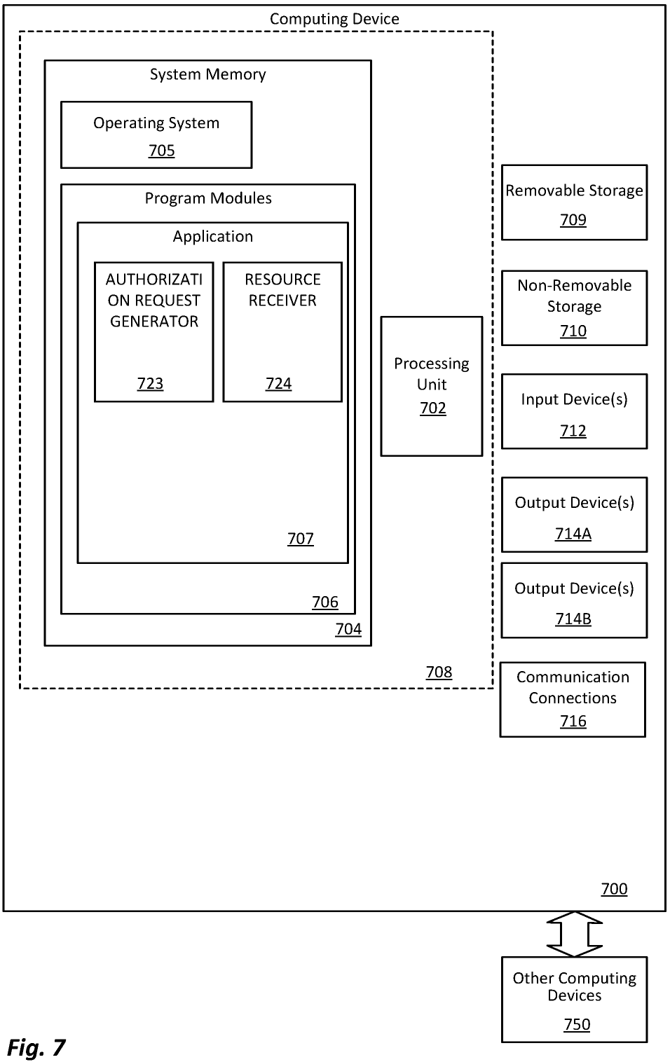

FIGS. 7-9 and the associated descriptions provide a discussion of a variety of operating environments in which aspects of the disclosure may be practiced. However, the devices and systems illustrated and discussed with respect to FIGS. 7-9 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above. For example, the computing device 700 may represent the computing device 130 of FIG. 1. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for performing the various aspects disclosed herein such. The operating system 705, for example, may be suitable for controlling the operation of the computing device 700. Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, several program modules and data files may be stored in the system memory 704. While executing on the at least one processing unit 702, the program modules 706 may perform processes including, but not limited to, one or more aspects, as described herein. The application 720 includes an authorization request generator 723 and an authorization receiver 724. The authorization request generator 723 is configured to generate an authorization request for a certain operation on a resource (e.g., a shared collaborative channel). The authorization receiver 724 is configured to receive an notification that indicates whether the authorization request has been granted.

Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. The output device(s) 714A such as a display, speakers, a printer, etc. may also be included. An output 714B, corresponding to a virtual display may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media (e.g., non-transitory media). Computer storage media may include non-transitory, volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

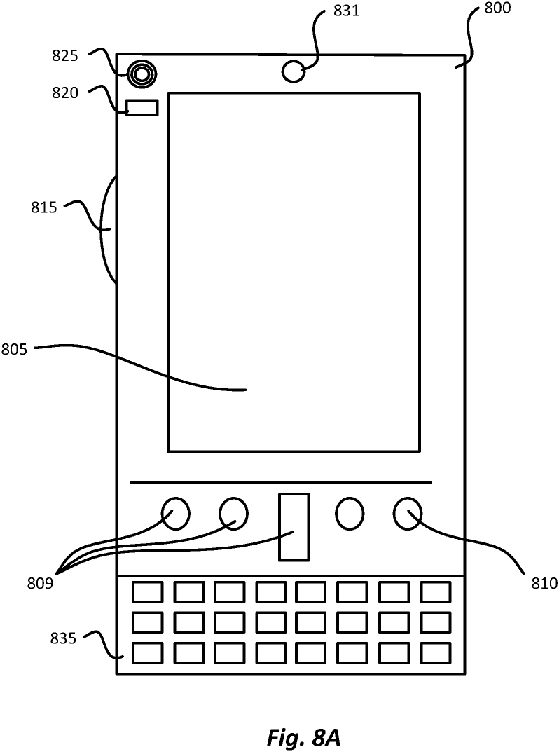

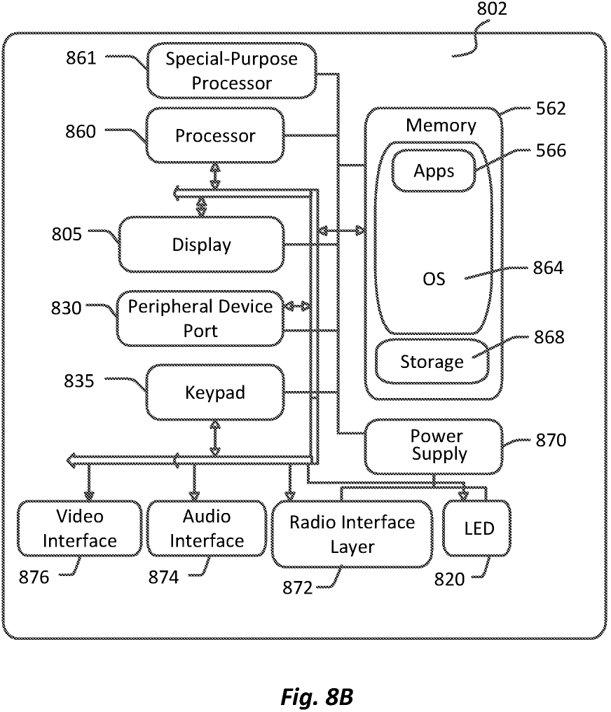

FIGS. 8A and 8B illustrate a computing device or mobile computing device 800, for example, a mobile telephone, a smart phone, wearable computer (such as a smart watch), a tablet computer, a laptop computer, and the like, with which aspects of the disclosure may be practiced. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 809/810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some aspects. In yet another alternative aspect, the mobile computing device 800 is a portable phone system, such as a cellular phone. The mobile computing device 800 may also include an optional keypad 835. Optional keypad 835 may be a physical keypad or a “soft” keypad generated on the touch screen display. In various aspects, the output elements include the display 805 for showing a graphical user interface (GUI), a visual indicator 831 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports 830, such as an audio input (e.g., a microphone jack), an audio output (e.g., a headphone jack), and a video output (e.g., a HDMI port) for sending signals to or receiving signals from an external source.

FIG. 8B is a block diagram illustrating the architecture of one aspect of computing device, a server, or a mobile computing device. That is, the mobile computing device 800 can incorporate a system (902) (e.g., an architecture) to implement some aspects. The system 802 can implemented as a “smart phone” capable of running one or more applications (e.g., browser, email, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and/or one or more components supported by the systems described herein. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein (e.g. an authorization request generator 723, an authorization receiver 724, etc.).

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated configuration, the visual indicator 820 is a light emitting diode (LED) and the audio transducer 825 is a speaker. These devices may be directly coupled to the power supply 870 so that when activated, they remain on for a duration dictated by the notification mechanism even though the processor 860/961 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of an on-board camera to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

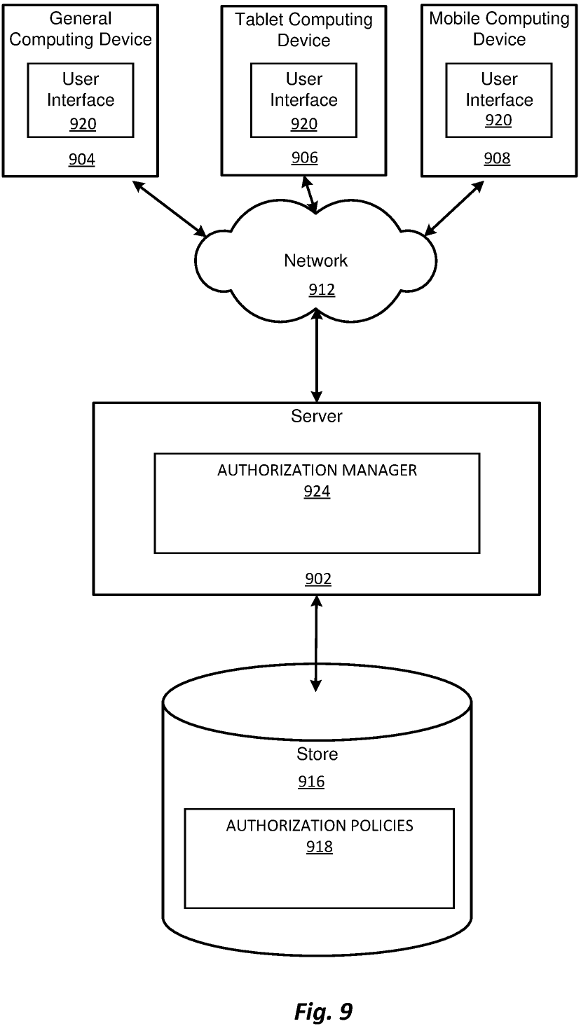

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, the computing device 904, 906, 908 may represent the computing device 130 of FIGS. 1-3, and the server device 902 may represent the collaborative platform server 110 of FIG. 1.

In some aspects, one or more of an authorization manager 924, may be employed by server device 902. The server device 902 may provide data to and from a client computing device such as a personal computer 904, a tablet computing device 906 and/or a mobile computing device 908 (e.g., a smart phone) through a network 912. By way of example, the computer system described above may be embodied in a personal computer 904, a tablet computing device 906 and/or a mobile computing device 908 (e.g., a smart phone). Any of these aspects of the computing devices may obtain content from the store 916, in addition to receiving graphical data useable to be either pre-processed at a graphic-originating system, or post-processed at a receiving computing system. The content store may include authorization policies data 918.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

1. A method for determining granular authorization of an authorization request for a user operation, the method comprising:
receiving the authorization request from a user requesting to perform the user operation on a resource;
evaluating the authorization request to identify one or more authorization claims for performing the user operation on the resource;
determining one or more claim providers for generating the one or more authorization claims, each of the one or more claim providers configured to generate at least one authorization claim of the one or more authorization claims for performing the user operation on the resource;
fetching the one or more authorization claims from the one or more claim providers;
evaluating one or more authorization policies to determine whether the user is authorized to perform the user operation on the resource;
determining permissions granted for the authorization request based on the evaluating the one or more authorization policies and the one or more authorization claims; and
in response to determining that the authorization request is granted, authorizing the user to perform the user operation on the resource.

2. The method of claim 1, further comprising authenticating the user based on identity information included in the authorization request.

3. The method of claim 1, wherein fetching the one or more authorization claims from the one or more claim providers further comprises fetching the one or more authorization claims while evaluating the one or more authorization policies.

4. The method of claim 1, wherein fetching the one or more authorization claims from the one or more claim providers further comprises prefetching one or more potential authorization claims prior to evaluating the one or more authorization policies.

5. The method of claim 4, wherein prefetching the one or more potential authorization claims further comprises:
determining one or more potential authorization claims for determining the permissions of the authorization request;
determining one or more claim providers that generates the one or more potential authorization claims, wherein the one or more claim providers include at least one of an actor entity, a resource entity, an organization, entity, and a subject entity;
causing the one or more claim providers to generate the one or more potential authorization claims; and
prefetching the one or more potential authorization claims.

6. The method of claim 1, further comprising:
fetching the one or more authorization policies by making API calls to the one or more policy providers; and
temporarily storing the one or more authorization policies in a shared cache.

7. The method of claim 1, wherein determining permissions granted for the authorization request by evaluating one or more authorization policies further comprises:
fetching one or more authorization claims from one or more claim providers on demand based on the one or more authorization policies; and
determining if the one or more authorization claims match values defined in the one or more authorization policies.

8. A computing device for determining granular authorization of an authorization request for a user operation, the computing device comprising:
a processor; and
a memory having a plurality of instructions stored thereon that, when executed by the processor, causes the computing device to:
receive the authorization request from a user requesting to perform the user operation on a resource;
authenticate the user based on identity information included in the authorization request;
evaluate the authorization request to identify one or more authorization claims for performing the user operation on the resource;
determine one or more claim providers for generating the one or more authorization claims, each of the one or more claim providers configured to generate at least one authorization claim of the one or more authorization claims for performing the user operation on the resource;
fetch the one or more authorization claims from the one or more claim providers;
evaluate one or more authorization policies for determining whether the user is authorized to perform the user operation on the resource, wherein the one or more authorization claims are fetched prior to or during evaluation of the one or more authorization policies;
determine permissions granted for the authorization request based on the evaluating the one or more authorization policies and the one or more authorization claims; and
in response to a determination that the authorization request is granted, authorize the user to perform the user operation on the resource.

9. The computing device of claim 8, wherein the one or more authorization claims are fetched during evaluation of the one or more authorization policies.

10. The computing device of claim 8, wherein to fetching the one or more authorization claims prior to evaluation of the one or more authorization policies further comprises causing the computing device to:
determine one or more potential authorization claims for determining the permissions of the authorization request;
determine one or more claim providers for generating the one or more potential authorization claims, wherein the one or more claim providers include at least one of an actor entity, a resource entity, an organization, entity, and a subject entity;
cause the one or more claim providers to generate the one or more potential authorization claims; and
prefetch the one or more potential authorization claims.

11. The computing device of claim 8, wherein the computing device is further configured to:
determine if the one or more authorization policies are stored in a shared cache;
in response to determining that the one or more authorization policies are not stored in the shared cache, fetch the one or more authorization policies by making API calls to the one or more policy providers; and
temporarily store the one or more authorization policies in the shared cache.

12. The computing device of claim 11, wherein the computing device is further configured to:
in response to determining that the one or more authorization policies are stored in the shared cache, fetch the one or more authorization policies from the shared cache.

13. The computing device of claim 8, wherein to determine permissions granted for the authorization request further comprises causing the computing device to:
fetch one or more authorization claims from one or more claim providers on demand based on the one or more authorization policies; and
determine if the one or more fetched authorization claims match values defined in the one or more authorization policies.

14. A non-transitory computer-readable medium storing instructions for determining granular authorization of an authorization request for a user operation, the instructions when executed by one or more processors of a computing device, cause the computing device to:
receive the authorization request from a user requesting to perform the user operation on a resource;
authenticate the user based on identity information included in the authorization request;
evaluate the authorization request to identify one or more authorization claims for performing the user operation on the resource;
determine one or more claim providers for generating the one or more authorization claims, each of the one or more claim providers configured to generate at least one authorization claim of the one or more authorization claims for performing the user operation on the resource;
fetch the one or more authorization claims from the one or more claim providers;
evaluate one or more authorization policies for determining whether the user is authorized to perform the user operation on the resource;
determine permissions granted for the authorization request based on the evaluating the one or more authorization policies and the one or more authorization claims; and
in response to a determination that the authorization request is granted, authorize the user to perform the user operation on the resource.

15. The non-transitory computer-readable medium of claim 14, wherein the instructions when executed by the one or more processors further cause the computing device to authenticate the user based on identity information included in the authorization request.

16. The non-transitory computer-readable medium of claim 14, wherein fetching the one or more authorization claims from the one or more claim providers further comprises fetching the one or more authorization claims while evaluating the one or more authorization policies.

17. The non-transitory computer-readable medium of claim 14, wherein fetching the one or more authorization claims from the one or more claim providers further comprises prefetching one or more potential authorization claims prior to evaluating the one or more authorization policies.

18. The non-transitory computer-readable medium of claim 17, wherein prefetching the one or more potential authorization claims further comprises to:
determine one or more potential authorization claims for determining the permissions of the authorization request;
determine one or more claim providers for generating the one or more potential authorization claims, wherein the one or more claim providers include at least one of an actor entity, a resource entity, an organization, entity, and a subject entity;
cause the one or more claim providers to generate the one or more potential authorization claims; and
prefetch the one or more potential authorization claims.

19. The non-transitory computer-readable medium of claim 14, wherein the instructions when executed by the one or more processors further cause the computing device to:
fetch the one or more authorization policies by making API calls to the one or more policy providers; and
temporarily store the one or more authorization policies in a shared cache.

20. The non-transitory computer-readable medium of claim 14, wherein determining permissions granted for the authorization request by evaluating one or more authorization policies further comprises to:
fetch one or more authorization claims from one or more claim providers on demand based on the one or more authorization policies; and
determine if the one or more authorization claims match values defined in the one or more authorization policies.
